(19) United States
(12) Patent Application Publication
(10) Pub. No.: US 2018/0019986 A1
(43) Pub. Date: Jan. 18, 2018

(54) USER PRIVACY PROTECTED LOCATION-BASED AUTHENTICATION ON MOBILE DEVICES

(71) Applicant: QUALCOMM Incorporated, San Diego, CA (US)

(72) Inventors: Bollapragada V.J. MANOHAR, San Diego, CA (US); Baranidharan Muthukumaran, San Diego, CA (US)

(21) Appl. No.: 15/208,382

(22) Filed: Jul. 12, 2016

(51) Int. Cl. H04L 29/06; H04L 12/06

(52) U.S. Cl. CPC H04L 63/08; H04L 12/06

(57) ABSTRACT

Techniques for implementing location-based authentication in a computing device are provided. An example method according to these techniques includes binding location authentication information to an authentication key for a relying party (RP) application, receiving a request from the RP application for a signed authentication response, obtaining current location information for the computing device, authenticating the current location information for the computing device based on the location authentication information bound to the authentication key, and providing, to the RP application by the computing device, the signed authentication response in response to the authenticating the current location information for the computing device, wherein the signed authentication response is signed using the authentication key bound to the location authentication information.

### BACKGROUND

A secure key management (SKM) service of a computing device typically binds user authentication information (e.g., biometric authentication information, personal identification number(s) (PINS) and/or passwords) to keys used for signing an authentication response for a relying party (RP) application. For example, the RP application may include a purchase or payment application used for financial transactions. Such binding provides enhanced security for the transactions of the RP application. Providing computing device location information to the RP application may further enhance transaction security. The SKM service may provide the location information to the RP application by adding the location information to the authentication certificate. In a service such as FIDO®, for example, the RP application collects the current location information as part of the user authentication procedure. The RP application may use the provided location information in order to limit transactions according to a geofence policy and/or to verify the user identification based on the provided location information. However, providing the location information to the RP application may compromise the security and/or privacy of the user of the computing device.

### SUMMARY

An example method of implementing location based authentication in a computing device according to the disclosure includes binding location authentication information to an authentication key for a relying party (RP) application, receiving a request from the RP application for a signed authentication response, obtaining, at the computing device, current location information for the computing device, authenticating, at the computing device, the current location information for the computing device based on the location authentication information bound to the authentication key, and providing, to the RP application by the computing device, the signed authentication response in response to the authenticating the current location information for the computing device, wherein the signed authentication response is signed using the authentication key bound to the location authentication information.

Implementations of such a method can include one or more of the following features. Providing the signed authentication response without providing the current location information to the RP application. Generating the location authentication information at the computing device, wherein the location authentication information is indicative of one or more allowed locations for transactions of the RP application. Binding location authentication information to an authentication key for a relying party (RP) application includes binding location information associated with multiple different locations to the authentication key. Binding location authentication information to an authentication key for a relying party (RP) application includes binding first location authentication information to a first authentication key for a first transaction of the RP application, and binding second location authentication information to a second authentication key for a second transaction of the RP application, wherein the second location authentication information is different than the first location authentication information. Receiving the request from the RP application for the signed authentication response further comprises receiving the request from the RP application for the signed authentication response for a particular transaction of the RP application, wherein the particular transaction comprises one of the first transaction or the second transaction. Authenticating the current location information for the computing device based on the location authentication information bound to the authentication key includes authenticating the current location information for the computing device based on bound location authentication information for the particular transaction, and the bound location authentication information for the particular transaction comprises one of the first location authentication information or the second location authentication information. Providing the signed authentication response in response to the authenticating the current location information for the computing device includes signing the signed authentication response using the authentication key corresponding to the particular transaction, and the authentication key corresponding to the particular transaction comprises one of the first authentication key bound with the first location authentication information or the second authentication key bound with the second location authentication information. Receiving the current location information for the computing device from a location authenticator trusted application of the computing device. Binding additional authentication information to the authentication key for the relying party (RP) application, authenticating the additional authentication information for the apparatus based on the additional authentication information bound to the authentication key, and providing, to the RP application by the computing device, the signed authentication response in response to the authenticating the current location information and the additional authentication information for the computing device, wherein the signed authentication response is signed using the authentication key bound to the location authentication information and the additional authentication information. The additional authentication information includes biometric information, device state information, authorization credentials, or a combination thereof

An example apparatus according to the disclosure includes means for binding location authentication information to an authentication key for a relying party (RP) application, means for receiving a request from the RP application for a signed authentication response, means for obtaining, at the apparatus, current location information for the apparatus, means for authenticating, at the apparatus, the current location information for the apparatus based on the location authentication information bound to the authentication key, and means for providing, to the RP application by the apparatus, the signed authentication response in response to the authenticating the current location information for the apparatus, wherein the signed authentication response is signed using the authentication key bound to the location authentication information.

Implementations of such an apparatus can include one or more of the following features. Means for providing the signed authentication response without providing the current location information to the RP application. Means for generating the location authentication information at the apparatus, wherein the location authentication information is indicative of one or more allowed locations for transactions of the RP application. The means for binding location authentication information to an authentication key for a relying party (RP) application includes binding location information associated with multiple different locations to the authentication key. The means for binding location authentication information to an authentication key for a relying party (RP) application includes means for binding first location authentication information to a first authentication key for a first transaction of the RP application, and means for binding second location authentication information to a second authentication key for a second transaction of the RP application, wherein the second location authentication information is different than the first location authentication information. The means for receiving the request from the RP application for the signed authentication response further includes means for receiving the request from the RP application for the signed authentication response for a particular transaction of the RP application, and the particular transaction comprises one of the first transaction or the second transaction. The means for authenticating the current location information for the computing device based on the location authentication information bound to the authentication key further comprises means for authenticating the current location information for the computing device based on bound location authentication information for the particular transaction, and the bound location authentication information for the particular transaction comprises one of the first location authentication information or the second location authentication information.

An apparatus according to the disclosure includes a memory and a processor coupled to the memory. The processor is configured to bind location authentication information to an authentication key for a relying party (RP) application, receive a request from the RP application for a signed authentication response, obtain, at the apparatus, current location information for the apparatus, authenticate, at the apparatus, the current location information for the apparatus based on the location authentication information bound to the authentication key, and provide, to the RP application by the apparatus, the signed authentication response in response to the authenticating the current location information for the apparatus, wherein the signed authentication response is signed using the authentication key bound to the location authentication information.

Implementations of such an apparatus can include one or more of the following features. The processor is further configured to provide the signed authentication response without providing the current location information to the RP application. The processor is further configured to generate the location authentication information at the apparatus, and wherein the location authentication information is indicative of one or more allowed locations for transactions of the RP application. The processor is further configured to bind location information associated with multiple different locations to the authentication key. The processor is being configured to bind location authentication information to an authentication key for a relying party (RP) application is further configured to bind first location authentication information to a first authentication key for a first transaction of the RP application, and bind second location authentication information to a second authentication key for a second transaction of the RP application, wherein the second location authentication information is different than the first location authentication information. The processor is further configured to receive the request from the RP application for the signed authentication response for a particular transaction of the RP application, and the particular transaction comprises one of the first transaction or the second transaction.

A non-transitory, computer-readable medium having stored thereon computer-readable instructions for implementing location based authentication in a computing device includes instructions configured to cause the computing device to bind location authentication information to an authentication key for a relying party (RP) application, receive a request from the RP application for a signed authentication response, obtain, at the computing device, current location information for the computing device, authenticate, at the computing device, the current location information for the computing device based on the location authentication information bound to the authentication key, and provide, to the RP application by the computing device, the signed authentication response in response to the authenticating the current location information for the computing device, wherein the signed authentication response is signed using the authentication key bound to the location authentication information.

Implementations of such a non-transitory, computer-readable medium can include one or of the following features. Instructions configured to cause the computing device to provide the signed authentication response without providing the current location information to the RP application. Instructions configured to cause the computing device to generate the location authentication information at the computing device, wherein the location authentication information is indicative of one or more allowed locations for transactions of the RP application. The instructions configured to cause the computing device to bind location authentication information to an authentication key for a relying party (RP) application include instructions configured to cause the computing device to bind location information associated with multiple different locations to the authentication key. The instructions configured to cause the computing device to bind location authentication information to an authentication key for a relying party (RP) application include instructions configured to cause the computing device to bind first location authentication information to a first authentication key for a first transaction of the RP application, and bind second location authentication information to a second authentication key for a second transaction of the RP application, wherein the second location authentication information is different than the first location authentication information. The instructions configured to cause the computing device to receive the request from the RP application for the signed authentication response further comprise instructions configured to cause the computing device to receive the request from the RP application for the signed authentication response for a particular transaction of the RP application, wherein the particular transaction comprises one of the first transaction or the second transaction.

### BRIEF DESCRIPTIONS OF THE DRAWINGS

FIG. 1 is a schematic diagram of an example of a communication system for a computing device.

FIG. 2 is a block diagram of hardware components of the computing device of FIG. 1.

FIG. 3 is a block diagram of an example of a computing device architecture for location based authentication.

FIG. 4 is a block diagram of an example process for implementing location based authentication.

FIG. 5 is a flow diagram of an example process for binding locations information to authentication keys in a computing device.

FIG. 6 is a flow diagram of an example process for implementing location-based authentication in a computing device.

FIG. 7 is a flow diagram of an example process for implementing location-based authentication in a computing device.

FIG. 8 is a flow diagram of an example process for implementing location-based authentication in a computing device.

FIG. 9 is a flow diagram of an example process for implementing location-based authentication in a computing device.

### DETAILED DESCRIPTION

Techniques are provided for implementing location-based authentication on a computing device. The techniques provided herein can be used to implement location binding in an secure key management (SKM) service. The location binding can be implemented with user authentication binding to further enhance the security of the SKM service. The techniques provide for secure key management for keys bound to location authentication information and/or user authentication information. The location authentication information and the user authentication information are processed within a trusted execution environment of the computing device and are not disclosed to the a replying party (RP) application utilizing the SKM service to ensure that sensitive user-related information is not disclosed.

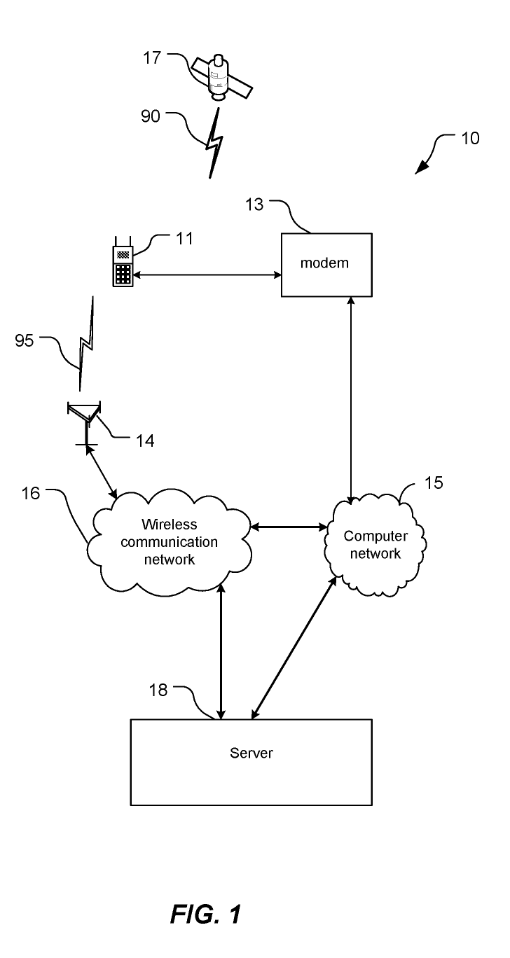

Referring to FIG. 1, a schematic diagram of an example of a communication system 10 is shown in which the techniques disclosed herein can be implemented. The communication system 10 includes a computing device 11, a modem 13, a communication network access device 14, a computer network 15, a wireless communication network 16, a satellite positioning system (SPS) satellite 17, and a server 18. The quantity of each component in FIG. 1 is an example only and other quantities of each, or any, component could be used. Furthermore, other components can be included in the communication system 10 in addition to or instead of one or more of the components illustrated in FIG. 1.

The computing device 11 is an electronic computing device and/or system. Although shown as a mobile phone in FIG. 1, the computing device 11 can be another electronic device. Examples of the computing device 11 include, for example but not limited to, an integrated circuit, a mainframe, a mini-computer, a server, a workstation, a set-top box, a personal computer, a laptop computer, a mobile device, a hand-held device, a wearable device, a wireless device, a navigation device, an entertainment appliance, a tablet, a modem, an electronic reader, a personal digital assistant, an electronic game, an automobile, an aircraft, a machinery, or combinations thereof. Claimed subject matter is not limited to a particular type, category, size, etc., of computing device.

The communication network access device 14 can be a base station, an access point, a femto base station, etc. The base station can also be referred to as, for example, a NodeB or an eNB (e.g., in the context of an LTE wireless network), etc. The communication network access device 14 can transmit/receive network signals 95 for use in wireless network communications. The modem 13 is a computer network access device and can include a router. The modem 13 is communicatively coupled to the computing device 11 and the computer network 15. The computer network 15 can include a mobile switching center and a packet data network (e.g., an Internet Protocol (IP) network referred to herein as the Internet). Although shown separately, the computer network 15 can be a portion of the wireless communication network 16.

The wireless communication network 16 can be communicatively coupled to the computing device 11, the communication network access device 14, the computer network 15, and/or the server 18. The wireless communication network 16 can include, but is not limited to, a wireless wide area network (WWAN), a wireless local area network (WLAN), a wireless personal area network (WPAN), and so on. The term “network” and “system” can be used interchangeably herein. A WWAN can be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network can implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 can include technologies implemented according to IS-95, IS-2000, and IS-856 standards. A TDMA network can implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN can include an IEEE 802.11x network, and a WPAN can include a Bluetooth network, an IEEE 802.15x, for example. Wireless communication networks can include so-called next generation technologies (e.g., “4G”), such as, for example, Long Term Evolution (LTE), Advanced LTE, WiMax, Ultra Mobile Broadband (UMB), and/or the like.

The server 18 can be, for example, but not limited to, a network server, a positioning server, an enterprise server, a server associated with a particular website and/or application, a cloud network server, or combinations thereof Although only one server 18 is shown in FIG. 1 for simplicity, other quantities of servers (e.g., one or more servers or a plurality of servers) could be used. The server 18 is a computing device including at least one processor and a memory and is configured to execute computer executable instructions. The processor is preferably an intelligent device, e.g., a personal computer central processing unit (CPU) such as those made by Intel® Corporation or AMD®, a microcontroller, an application specific integrated circuit (ASIC), etc. The memory includes a non-transitory, processor-readable storage medium that stores processor executable and processor-readable instructions (i.e., software code) that are configured to, when executed, cause the processor to perform various functions as may be described herein (although the description may refer only to the processor performing the functions). The memory can include random access memory (RAM) and read-only memory (ROM). The computer network 15 and/or the wireless communication network 16 can communicatively couple the server 18 to the computing device 11. For example, the communication network access device 14 and/or the modem 13 can communicate with the server 18 and retrieve information for use by the computing device 11. The configuration of the server 18 as a remote server is exemplary only and not a limitation. In an embodiment, the server 18 can be connected directly to the communication network access device 14, or the functionality can be included in the communication network access device 14. The server 18 can include one or more databases. In an example, the server 18 is comprised of multiple server units. The multiple server units can be administered by one or more enterprises.

The SPS satellite 17 includes suitable logic, circuitry, and code to generate and send radio-frequency (RF) SPS signals 90 that can be received at the computing device 11 for use in determining an SPS-based position of the computing device 11. The SPS can include such systems as the Global Positioning System (GPS), Galileo, Glonass, Compass, Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that can be associated with or otherwise enabled for use with one or more global and/or regional navigation satellite systems. By way of example but not limitation, an SBAS can include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. In some embodiments, the techniques/procedures presented herein are not restricted to global systems (e.g., GNSS) for SPS. For example, the techniques provided herein can be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., a Satellite Based Augmentation System (SBAS)) that can be associated with or otherwise enabled for use with one or more global and/or regional navigation satellite systems. By way of example but not limitation, an SBAS can include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS can include any combination of one or more global and/or regional navigation satellite systems and/or augmentation systems, and SPS signals can include SPS, SPS-like, and/or other signals associated with such one or more SPS.

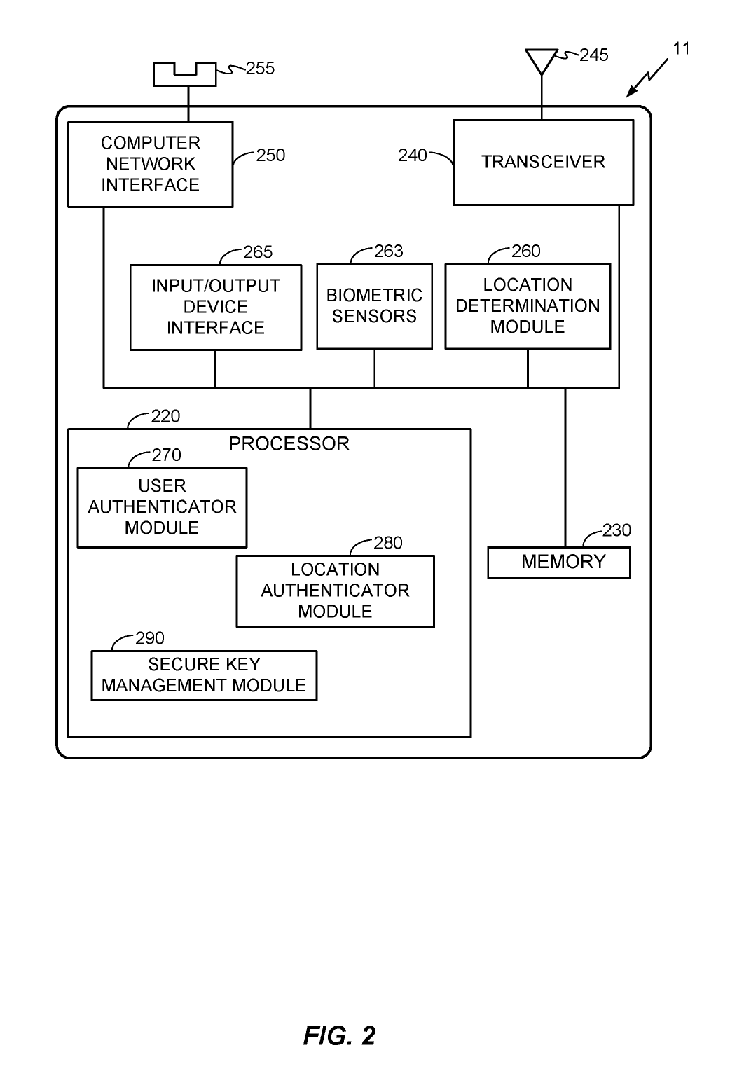

Referring to FIG. 2, with further reference to FIG. 1, a block diagram of hardware components of an example computing device that can be used to implement the computing device 11 of FIG. 1 is shown. A quantity of each component in FIG. 2 is an example only and other quantities of each, or any, component could be used. Furthermore, one or more of the component can be omitted and other components included in other implementations of the computing device 11.

The computing device 11 includes a processor 220, a memory 230, a transceiver 240, an antenna 245, a computer network interface 250, a wired connector 255, a location determination module 260, biometric sensors 263, and an input/output device interface 265. The components 220, 230, 240, 250, 260, 263, and 265 are communicatively coupled (directly and/or indirectly) to each other for bi-directional communication. Although shown as separate entities in FIG. 2, the transceiver 240 and the computer network interface 250 can be combined into one or more discrete components and/or can be part of the processor 220.

The transceiver 240 can send and receive wireless signals via the antenna 245 over one or more wireless networks, for example, the wireless communication network 16 in FIG. 1. The computing device 11 is illustrated as having a single transceiver 240. However, the computing device 11 can alternatively have multiple transceivers 240 and/or antennas 245 to support multiple communication standards such as Wi-Fi, Code Division Multiple Access (CDMA), Wideband CDMA (WCDMA), Long Term Evolution (LTE), Bluetooth, etc. The transceiver 240 can be further configured to enable the computing device 11 to communicate and exchange information, either directly or indirectly with other communications network entities (e.g., the server 18, the communication network access device 14). The transceiver 240 can also be configured to enable the computing device 11 to receive the SPS signals 90 (e.g., from the SPS satellite 17 in FIG. 1).

The wired connector 255 to the computer network interface 250 can enable a wired connection between the computing device and the computer network 15. The computer network interface 250 can include appropriate hardware, including one or more processors (not shown), to couple to and communicate with, for example, the modem 13 and the computer network 15. The computer network interface 250 can include a network interface card (NIC) to enable Internet protocol (IP) communication. Additionally or alternatively, the communicative coupling between the computing device 11 and the computer network 15 can be via a wireless connection (e.g., via the transceiver 240 and the antenna 245).

The location determination module 260 is configured to communicate with the transceiver 240 and the processor 220 to process SPS signals 90 and/or network signals 95 to obtain location information for the computing device 11. The location information can include global navigation satellite system (GNSS) information, communications network information, mapping information, context information, geographic range information, routing information, indoor/outdoor information, etc. Although shown as a separate entity in FIG. 2, in an embodiment, the location determination module 260 can be part of the processor 220.

The biometric sensors 263 can include, for example but not limited to, fingerprint sensors, iris or retina eye-scan sensors, facial recognition sensors, hand geometry sensors, spectral biometric sensors, voice recognition sensors, and/or combinations thereof. A biometric is a physiological characteristic that provides a distinctive, measurable identifier of an individual. A biometric input to the biometric sensors 263 can include, for example, but not limited to, a fingerprint, palm vein information, a facial image, DNA information, a palm print, an iris scan, a retinal scan, a voice recording, etc. An example of the biometric sensors 263 can include an optical, injected radio frequency (RF), or capacitive scanner disposed in a housing which provides a contact area where placed or swiped fingerprints are captured. Further examples of the biometric sensors 263 can include a camera, scanner, microphone, accelerometer, magnetometer, light sensor, proximity sensor, gyroscope, pressure sensor, temperature sensor, blood pressure sensor, etc. Input/output devices such as a mouse, a keyboard, or a joystick can also provide biometric information.

The input/output device interface 265 is communicatively coupled to input/output devices and the processor 220 to process signals from the input/output devices. The input/output devices can include, for example, but not limited to, a display panel, a touch screen, a pointing device (such as a mouse, trackball, stylus, etc.), a keyboard, a microphone or other voice input device, a joystick, a camera, etc., or combinations thereof (e.g., a keyboard and a mouse). The input/output devices can be physically separate from the computing device 11 or can be physically connected and/or co-extensive with the computing device 11.

The memory 230 includes a non-transitory, processor-readable storage medium that stores processor executable and processor-readable instructions (i.e., software code) that are configured to, when executed, cause the processor 220 to perform various functions described herein (although the description can refer only to the processor 220 performing the functions). Alternatively, the software code can not be directly executable by the processor 220 but configured to cause the processor 220, e.g., when compiled and executed, to perform the functions. The memory 230 can include, but is not limited to, RAM, ROM, flash, disc drives, fuse devices, etc. The memory 230 can be long term, short term, or other memory associated with the computing device 11 and is not to be limited to any particular type of memory or number of memories, or type of media upon which memory is stored. The memory 230 is operably coupled to the processor 220. The processor 220 either alone, or in combination with the memory 230, provides means for performing functions as described herein, for example, executing code or instructions stored in the memory 230.

The processor 220 is a physical processor (i.e., an integrated circuit configured to execute operations on the computing device 11 as specified by software and/or firmware). The processor 220 can be an intelligent hardware device, e.g., a central processing unit (CPU), one or more microprocessors, a controller or microcontroller, an application specific integrated circuit (ASIC), a general-purpose processor, a digital signal processor (DSP), a field programmable gate array (FPGA) or other programmable logic device, a state machine, discrete gate or transistor logic, discrete hardware components, or any combination thereof designed to perform the functions described herein and operable to carry out instructions on the computing device 11. The processor 220 can be one or more processors and can be implemented as a combination of computing devices (e.g., a combination of DSP and a microprocessor, a plurality of microprocessors, one or more microprocessors in conjunction with a DSP core, or any other such configuration). The processor 220 along with memory 230 can be components of a system-on-chip (SoC). The processor 220 can include multiple separate physical entities that can be distributed in the computing device 11.

The processor 220 can support a system-wide trusted execution environment (TEE) security platform. Example implementations of the TEE include, but are not limited to, Open Source TEE (OP-TEE) and QUALCOMM® Secure Execution Environment (QSEE), Intel® TXT, and AMD® Secure Execution Environment. The TEE security platform partitions hardware and software resources of the processor 220 and the memory 230 to create a secure world processing environment and a non-secure world processing environment. The non-secure world processing environment is typically referred to as a Rich Execution Environment (REE). The TEE and the REE can be embedded in one processor or in separate processors. The TEE is a security focused execution environment designed to store and manipulate sensitive information and to keep this information private from the REE. The REE interacts with the user of the computing device 11 via a high level operating system (HLOS) (e.g., iOS®, Android®, Windows®, Blackberry®, Chrome®, Linux®, Symbian®, Palm®, etc.).

The processor 220 can include a user authenticator unit 270, a location authenticator unit 280, and a secure key management (SKM) unit 290. The units 270, 280, and 290 are functional units implemented by the processor 220. Thus reference to the processor 220 performing a function is equivalent to the respective units(s) 270, 280, 290 performing the function. Similarly, reference to any of the unit 270, 280, 290 performing or being configured to perform a function is shorthand for the processor 220 performing the function in accordance with software and/or hardware and/or firmware and/or combinations thereof

The user authenticator unit 270 is configured to receive authentication information from the biometric sensors 263 and/or the input/output device interface 265. Based on the received authentication information, the user authenticator unit 270 can authenticate the identity of the user of the computing device 11.

The location authenticator unit 280 is configured to receive location information from the location determination module 260 and/or the computer network interface 250. Based on the received location information, the location authenticator module can authenticate the location of the computing device 11.

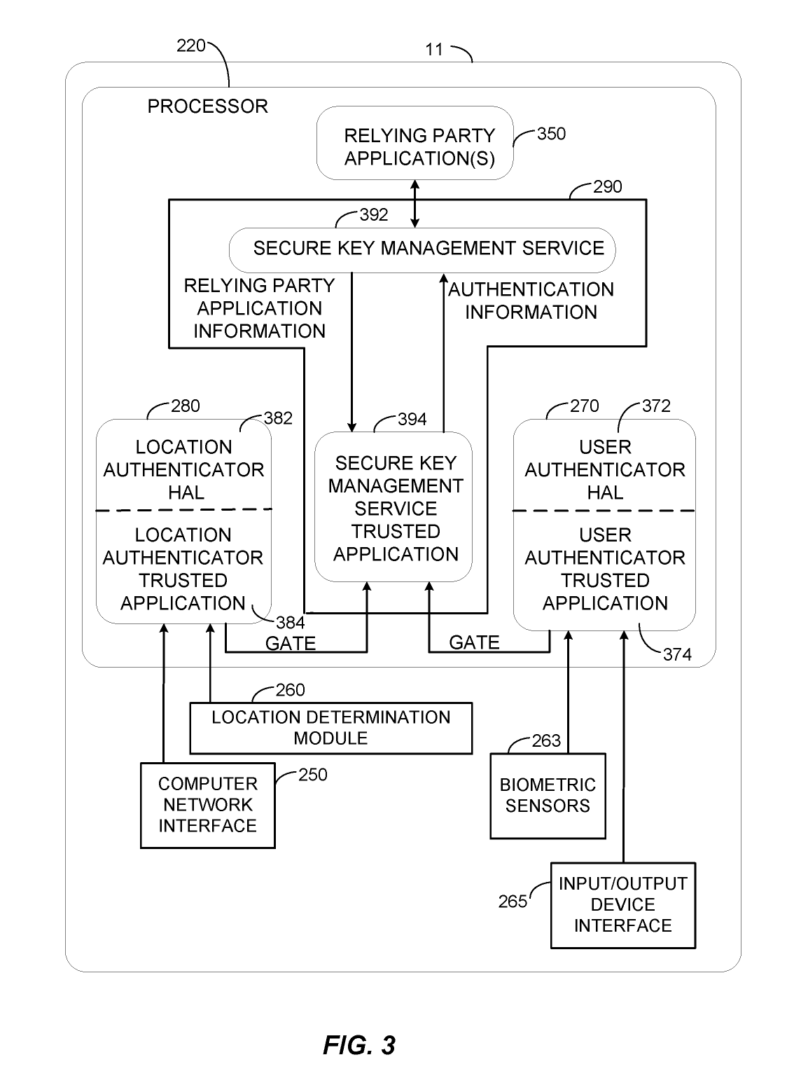

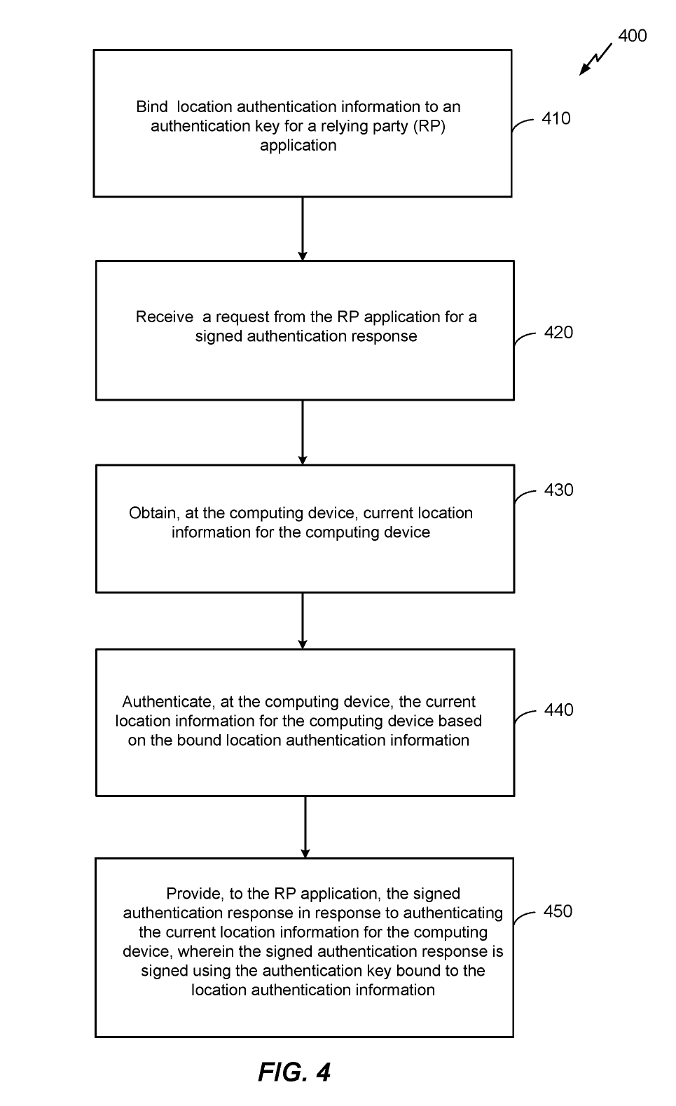

The SKM unit 290 is configured to receive user authentication information from the user authenticator unit 270 and to receive location authentication information from the location authenticator unit 280. The SKM unit 290 is further configured to receive and provide information to applications executing in the processor 220. In particular, the SKM module is configured to receive requests for signed authentication responses from the applications and to provide the signed authentication responses to the applications. Functions of the units 270, 280, and 290 are described in further detail below with regard to the functional block diagram of a computing device illustrated in FIG. 3 and with regard to the processes illustrated in FIGS. 4-9.

FIG. 3, with further reference to FIGS. 1-2, is a block diagram of an example of a computing device architecture for location based authentication. As discussed above with regard to FIG. 2, the processor 220 includes user authenticator unit 270, the location authenticator unit 280, and the SKM unit 290. The SKM unit 290 provides secures storage and management of cryptographic keys. For example, the SKM unit 290 can be configured to implement the Android®KeyStore® and Android®KeyMaster® security mechanisms. These security mechanisms are not limiting of the disclosure as other security mechanisms performing similar functions for an operating system can be implemented by the SKM unit 290. These security mechanisms can be implemented by the SKM unit 290 a SKM trusted service application in the TEE of the processor 220.

The location authenticator unit 280 can include a location authentication hardware abstraction layer (HAL) 282 and a location authenticator trusted application 384. The location authentication HAL 382 can be configured to provide an interface between the location authenticator trusted application 384, which is configured to operate within the TEE of the processor 220 and one or more hardware components of the computing device 11 that can be used to determine the location of the computing device 11. For example, the location authentication HAL 382 can be configured to interface with the computer network interface 250 and/or the location determination module 260 of the computing device 11. The location authentication HAL 382 can be configured to send a request to the location determination module 260 of the computing device 11 to obtain current location information for the computing device 11. The location determination module 260 may be implemented at least in part in the REE of the computing device 11. The location determination module 260 can be configured to use various means, such as signals from one or more SPS satellites, wireless network signals, and/or other information, to determine a location of the computing device 11. The location authentication HAL 382 can also be configured to obtain location information via the computer network interface 250 of the computing device 11. The location authentication HAL 382 can be configured to contact a server, such as the server 18, which can be configured to provide location information to the computing device 11.

The location authenticator trusted application 384 can be configured obtain location information for the computing device 11 via the location authentication HAL 382. The location authenticator trusted application 384 can be configured to make a determination whether the current location of the computing device 11 falls within a required location bound to an authentication key. The location authenticator trusted application 384 can be configured receive a location verification request from the SKM 290. The location verification request can include location information bound to an authentication key associated with an RP application 350 for which the SKM 290 is attempting to authenticate the user. The location authenticator trusted application 384 can be configured obtain location information via the location authentication HAL 382 responsive to the location verification request and to make a determination whether the current location of the computing device 110 falls within location authentication information bound to the authentication key. The location authenticator trusted application 384 can be configured generate an authentication token and to pass the authentication token to the SKM 290 responsive to the current location of the computing device 11 falling within the area defined by the location information bound to an authentication key. The location authenticator trusted application 384 can also be configured to generate and send an error message to the SKM 290 responsive to the current location of the computing device 11 not falling within the area defined by the location information bound to an authentication key.

The user authenticator unit 270 can include a user authenticator HAL 372 and a user authenticator trusted application 374. The user authenticator HAL 372 can be configured to provide an interface between the user authenticator trusted application 374, which is configured to operate within the TEE of the processor 220 and one or more hardware components of the computing device 11 that can be used to authenticate the user of the computing device 11. For example, the user authenticator HAL 372 can be configured to interface with the biometric sensors 263 and/or the I/O device interface 265 of the computing device 11. The user authenticator trusted application 374 can be configured to obtain user authentication information for the computing device 11 via the user authenticator HAL 372. The user authenticator trusted application 374 can be configured to make a determination whether the user authentication information provided by the user of the computing device 11 matches user authentication information bound to an authentication key. The user authenticator trusted application 374 can be configured receive a user authentication request from the SKM 290. The user authentication request can include user authentication information bound to an authentication key associated with an RP application 350 for which the SKM 290 is attempting to authenticate the user, such as biometric information and/or a password or PIN. The location authenticator trusted application 384 can be configured obtain user authentication information via the user authenticator HAL 372 responsive to the user authentication request and to make a determination whether the user authentication information obtained from a user of the computing device matches user authentication information bound to the authentication key. The user authenticator trusted application 374 can be configured generate an authentication token and to pass the authentication token to the SKM 290 responsive to the authentication information matching the authentication information bound to an authentication key. The user authenticator trusted application 374 can also be configured to generate and send an error message to the SKM 290 responsive to the authentication information not matching the authentication information bound to an authentication key.

The RP application(s) 350 are third party applications that can operate in the REE of the processor 220. The RP application(s) 350 can be configured to perform transactions on behalf of a user of the computing device 11, such as making purchases and/or making payments on behalf of the user of the computing device 11. The RP application(s) 350 can be configured to require varying levels of authentication based on a risk associated with a transaction. Each level of authentication can be associated with a key bound to the user's accounts. For example, an RP application can be configured to associate transactions of less than a first threshold monetary amount with a first authentication key, in which the key is bound to a pin or passcode or to biometric information. The RP application can be configured to associate transactions at or above the first threshold monetary amount and less than a second threshold monetary amount with a second authentication key, in which the key is bound to biometric data only. The RP application can be configured to associate transactions at or above the second threshold monetary amount with a third authentication key, in which the key is bound to biometric data and to a specific geographical area. For example, the geographical area might comprise a city, county, state, or country in which the computing device 11 must be located in order for the transaction to be performed. The granularity of the geographical area can be configured to be a larger area or can be very specific. The geographical area can be defined as a specific set of addresses (e.g., an address for work, home, school, etc.) or can be defined as sets of geographical coordinates that define areas in which a particular transaction should be permitted, assuming any other user authentication requirements associated with the transaction have also been satisfied).

The authentication keys and the binding information are securely stored by the SKM unit 290 such that the authentications keys and the binding information is substantially inaccessible from outside of the TEE of the computing device 11 and access may be limited to certain trusted applications operating within the TEE of the computing device 11. The SKM unit 290 is configured to provide the location information bound to an authentication key to the location authenticator unit 280 and the user authentication information bound to an authentication key to the user authenticator unit 270 in order to receive an authentication from the location authenticator unit 270 and the user authenticator unit 270 responsive to the user information and/or current location of the computing device 11 being authenticated. The location information and the user authentication information are kept secret and are not released from the TEE of the computing device 11 in order to protect the privacy and security of the user of the computing device 11. The RP application(s) 350 do not obtain the location information and/or the user authentication information utilized by location authenticator trusted application 384 and the user authenticator trusted application 374 on behalf of the SKM 290 to make the authentication determination. Instead, the SKM 290 attests that the user has satisfied the authentication requirements bound to the appropriate authentication key associated with the RP application 350, and the RP application 350 can feed the attestation into a risk assessment engine with additional information (if available) to make a determination whether to proceed with a requested transaction. The SKM 290 is configured to securely store the keys associated with the RP application and to only sign a response with a particular key responsive to the location authentication information and/or the user authentication information requirements bound to the key being satisfied. The SKM 290 can provide the attestation information in the form of a signed authentication response. The signed authentication response can be signed using an authentication key selected by the RP application 350 and identified in the request for a signed authentication response received at the SKM 290 from the RP application 350. The selected authentication key the key associated with the type of transaction that the user is attempting to perform using the RP application 350. The signed authentication response serves as an attestation by the SKM 290 that the location authentication information and/or the user authentication information requirements bound to the authentication key have been satisfied.

FIG. 4 is a flow diagram of an example process 400 for implementing location-based authentication in a computing device. The process illustrated in FIG. 4 can be implemented by the computing device 11 illustrated in FIG. 1-3. The process 400 is, however, an example only and not limiting. The process 400 can be altered, e.g., by having stages added, removed, rearranged, combined, and/or performed concurrently.

Location authentication information can be bound to an authentication key for a replying party (RP) application (stage 410). Location authentication information can comprise information that defines a geographical area or areas in which a current location of the computing device 11 falls at the time that a transaction using the key is attempted. An authentication key can be bound to more than one geographical area. A geographical area can be a set of one or more of addresses (e.g., an address for work, home, school, etc.) and/or can include one or more sets of geographical coordinates that an define area or areas in which a particular transaction should be permitted, assuming any other user authentication requirements associated with the transaction have also been satisfied). The location authentication information can be determined by a provider of the RP application, such as a financial institution, an investment institution, an online retailer, or other type of goods or service provider, to secure transactions conducted through the RP application. The location authentication information can also be determined, at least in part, by a user of the RP application and/or the computing device 11 to conduct secure transactions through the RP application. The provider of the RP application can provide default location authentication information that limits transactions through the RP application to a certain region or regions in which the provider of the RP application conducts business or in which the user of the RP application is believed to reside. The size of a region can vary. A region can comprise a town, village, city, county, state, province, prefecture, or a country. Other types of geographical regions can also be used. The user of the RP application can also define location authentication information for the RP application. For example, the user of the RP application may wish to restrict transactions with the RP application to a more limited geographical area or areas than included in the default location authentication information provided by the RP application provider or the RP application provider may not provide such geographical limitations but user may wish to impose such limitations. The RP application 350 can include a user interface that allows the user to define new and/or edit existing location authentication information. The user interface can be configured to require the user to provide user authentication information, such a pin or password or biometric information to unlock the interface that enables the user to configure the location authentication information. The location authentication information and the authentication keys to which the location authentication is bound can be stored in a secure memory location of the computing device 11, such as a memory location associated with the TEE of the computing device 11. User authentication information can also be bound to the one or more authentication keys and can be stored in the secure memory location as well.

A request can be received from the RP application for a signed authentication response (stage 420). The RP application 350 can send a request to the SKM 290 of the computing device 11 requesting a signed authentication response from the SKM 290. The RP application 350 can be configured to send the request to the SKM 290 in response to the user attempting to perform a transaction using the RP application 350. The request from the RP application can include a key identifier indicating which key that the RP application 350 has selected. An RP application can be associated with more than one key and each key can be associated with its associated with its own location authentication information. The selected key can also be associated with user authentication requirements. The SKM 290 is configured to securely store the keys associated with the RP application and to only sign a response with a particular key responsive to the location authentication information and/or the user authentication information requirements bound to the key being satisfied.

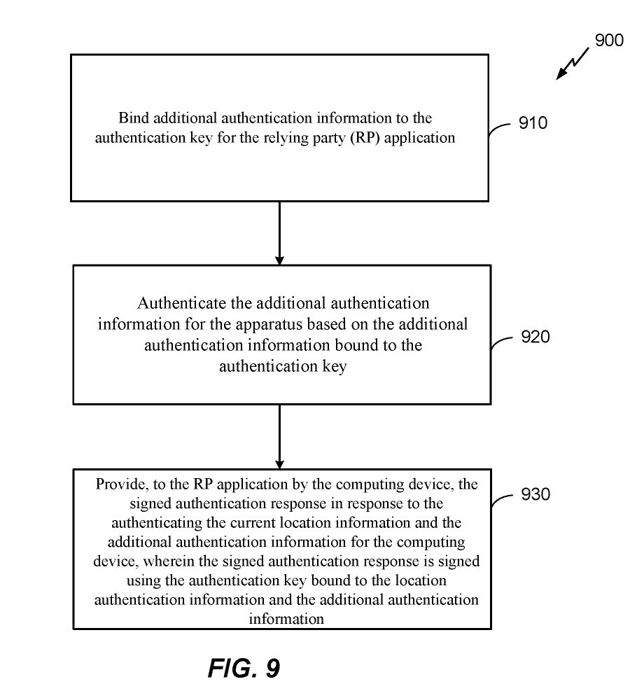

Current location information for the computing device can be obtained (stage 430). The SKM 290 can provide location authentication information associated with the selected authentication key to the location authenticator unit 280 with a request for the location authentication. The location authenticator trusted application 384 of the location authenticator unit 280 can obtain current location information for the computing device 11 from the location authentication HAL 382. The current location information for the computing device 11 is kept within the location authenticator trusted application 384 which is being executed within the TEE of the computing device 11. The current location information is not provided to the RP application 350, thereby avoiding privacy concerns associated with the dissemination of such location information. The user authentication unit 270 can also be configured to obtain user authentication information where the key associated with location authentication information and user authentication information. An example of such a transaction is illustrated in FIG. 9.

The current location information for the computing device can be authenticated based on the bound location authentication information (stage 440). The location authenticator trusted application 384 can make a determination whether the current location of the computing device 11 satisfies the geographical requirements indicated in the location authentication information bound to the authentication key selected by the RP application 350. The location authenticator trusted application 384 can be configured to provide an authentication token to the SKM 290 responsive to the current location of the computing device satisfying the geographical requirements indicated in the location authentication information bound to the authentication key selected by the RP application 350. The location authenticator trusted application 384 can also be configured to generate and send an error message to the SKM 290 responsive to the current location of the computing device not satisfying the geographical requirements indicated in the location authentication information bound to the authentication key selected by the RP application 350.

The signed authentication response can be provided to the RP application responsive to authenticating the current location information for the computing device (stage 450). The SKM 290 can be configured to receive the authentication token from the location authenticator trusted application 384 and to generate a signed authentication response to the RP application 350 responsive to receiving the location authentication token. The SKM 290 can be configured to receive the authentication token from the location authenticator trusted application 384 and a user authentication token from the user authenticator trusted application 374 and to generate a signed authentication response to the RP application 350 responsive to receiving the location authentication token and the user authentication token where the key selected in stage 420 was bound to both location authentication information and user authentication information. The signed authentication response can be signed using an authentication key selected by the RP application 350 and identified in the request for a signed authentication response received at the SKM 290 from the RP application 350. The signed authentication response serves as an attestation by the SKM 290 that the location authentication information and/or the user authentication information requirements bound to the authentication key have been satisfied. The RP application receiving the signed authentication response can determine that the attestation originated from the SKM 290 and that the authentication criteria associated with the requested transaction have been met and can complete the requested transaction.

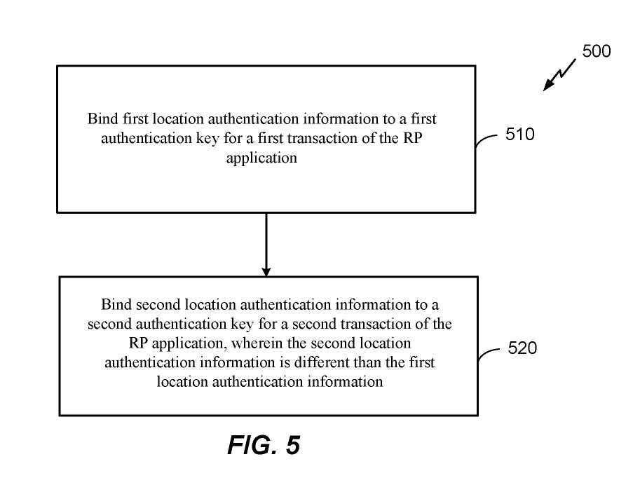

FIG. 5 is a flow diagram of an example process 500 for binding location authentication information to authentication keys in a computing device. The process illustrated in FIG. 5 can be implemented by the computing device 11 illustrated in FIG. 1-3. The process 500 is, however, an example only and not limiting. The process 500 can be altered, e.g., by having stages added, removed, rearranged, combined, and/or performed concurrently. The process 500 can be used to implement, at least in part, stage 410 of the process 400 illustrated in FIG. 4 where location information is bound to more than one transaction or type of transaction.

First location authentication information can be bound to a first authentication key for a first transaction associated with the RP application (stage 510). The SKM 290 can be configured to receive first location authentication information and an authentication key from the RP application. The first location authentication information can also be received, at least in part, from a user of the RP application 350 as discussed above. The first location authentication information can include a set of one or more addresses (e.g., an address for work, home, school, etc.) or can a set of one or more sets of geographical coordinates that an define area or areas in which a particular transaction should be permitted, assuming any other user authentication requirements associated with the transaction have also been satisfied). The RP application and/or the user of the computing device 11 can also provide user authentication information that can be bound to the first authentication key. The SKM 290 can be configured to store the first location authentication information and the first authentication key to which the first location authentication information is bound in a secure memory location of the TEE of the computing device 11, such that this information is substantially inaccessible from outside of the TEE of the computing device 11. The SKM 290 can also be configured to store the user authentication information bound to the first authentication certificate in a secure memory location of the TEE of the computing device 11 responsive to the user authentication information being provided in addition to the first location authentication information. The RP application 350 can be configured to associate the first authentication key with one or more transaction types that can be performed using the RP application 350 and can be configured to identify the first authentication key to the SKM 290 responsive to such a transaction being initiated by a user of the RP application 350.

Second location authentication information can be bound to a second authentication key for a second transaction of the RP application (stage 520). The second location authentication information is different than the first location authentication information. The SKM 290 can be configured to receive the second location authentication information and the second authentication key from the RP application. As discussed in the examples above, the RP application 350 can be configured to place different geographical restrictions on different types of transactions, and the SKM 290 can bind an authentication key associated with each time of transaction with location authentication information associated with that type of transaction. The second location authentication information can also be received, at least in part, from a user of the RP application 350 as discussed above. The second location authentication information can include a set of one or more addresses (e.g., an address for work, home, school, etc.) or can a set of one or more sets of geographical coordinates that an define area or areas in which a particular transaction should be permitted. The RP application and/or the user of the computing device 11 can also provide user authentication information that can be bound to the second authentication key. The SKM 290 can be configured to store the second location authentication information and the second authentication key to which the second location authentication information is bound in a secure memory location of the TEE of the computing device 11, such that this information is substantially inaccessible from outside of the TEE of the computing device 11. The SKM 290 can also be configured to store the user authentication information bound to the second authentication certificate in a secure memory location of the TEE of the computing device 11 responsive to the user authentication information being provided in addition to the second location authentication information. The RP application 350 can be configured to associate the second authentication key with one or more transaction types that can be performed using the RP application 350 and can be configured to identify the second authentication key to the SKM 290 responsive to such a transaction being initiated by a user of the RP application 350.

The example illustrated in FIG. 5 illustrates an example where an RP application is associated with two keys that are each bound to different location authentication information. However, the processes illustrated in FIG. 5 can be extended to associate location authentication information with more than two keys. The specific number of keys associated with a particular RP application can depend on the security requirements associated with a RP application and may be customizable, at least in part, by a provider of a service associated with the RP application and/or a user of the computing device 11 and the RP application. Furthermore, each authentication key can also be bound to user authentication information in addition to the location authentication information.

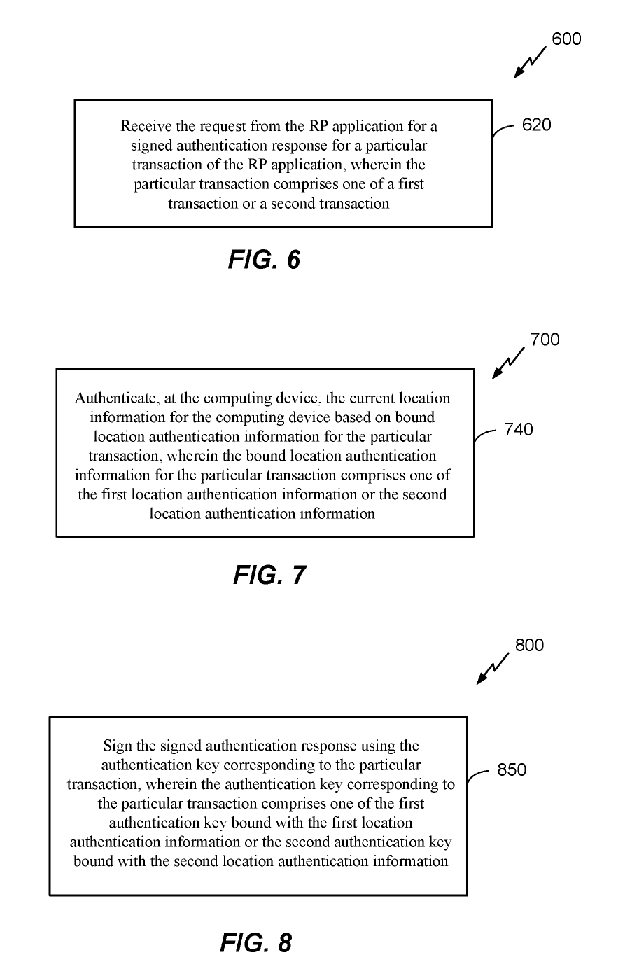

FIG. 6 is a flow diagram of an example process 600 for implementing location-based authentication in a computing device. The process illustrated in FIG. 6 can be implemented by the computing device 11 illustrated in FIG. 1-3. The process 600 is, however, an example only and not limiting. The process 600 can be altered, e.g., by having stages added, removed, rearranged, combined, and/or performed concurrently. The process 600 can be used to implement, at least in part, stage 420 of the process 400 illustrated in FIG. 4 where location information is bound to more than one transaction or type of transaction.

A request can be received from the RP application for a signed authentication response associated with a particular transaction of a plurality of transactions (stage 620). For example, the particular transaction can comprise a first transaction and a second transaction as illustrated in the example process illustrated in FIG. 5, but the process illustrated in FIG. 6 can be applied to implementations where the RP Application 350 has bound location authentication information and/or user authentication information to more an authentication key associated more two different types of transaction. The RP application 350 can send a request to the SKM 290 of the computing device 11 requesting a signed authentication response from the SKM 290. The RP application 350 can be configured to send the request to the SKM 290 in response to the user attempting to perform a transaction using the RP application 350, which may be either the first or the second transaction in this example implementation. The request from the RP application can include a key identifier indicating which key that the RP application 350 has selected, where the key is associated with the transaction to be performed. An RP application can be associated with more than one key and each key is associated with its own location authentication information. The selected key can also be associated with user authentication requirements. The SKM 290 is configured to securely store the keys associated with the RP application and to only sign a response with a particular key responsive to the location authentication information and/or the user authentication information requirements bound to the key being satisfied.

FIG. 7 is a flow diagram of an example process 700 for implementing location-based authentication in a computing device. The process illustrated in FIG. 7 can be implemented by the computing device 11 illustrated in FIG. 1-3. The process 700 is, however, an example only and not limiting. The process 700 can be altered, e.g., by having stages added, removed, rearranged, combined, and/or performed concurrently. The process 700 can be used to implement, at least in part, stage 440 of the process 400 illustrated in FIG. 4 where location information is bound to more than one transaction or type of transaction.

The current location information for the computing device can be authenticated based on the bound location authentication information for the particular transaction of the plurality of supported transaction types associated with the RP application (stage 740). The RP application can identify which authentication key is associated with the request for the signed authentication response. The SKM 290 can provide location authentication information associated with the selected authentication key to the location authenticator unit 280 with a request for the location authentication. The location authenticator trusted application 384 of the location authenticator unit 280 can obtain current location information for the computing device 11 from the location authentication HAL 382. The current location information for the computing device 11 is kept within the location authenticator trusted application 384 which is being executed within the TEE of the computing device 11. The current location information is not provided to the RP application 350, thereby avoiding privacy concerns associated with the dissemination of such location information. The location authenticator trusted application 384 can be configured to provide an authentication token to the SKM 290 responsive to the current location of the computing device satisfying the geographical requirements indicated in the location authentication information bound to the authentication key selected by the RP application 350. The location authenticator trusted application 384 can also be configured to generate and send an error message to the SKM 290 responsive to the current location of the computing device satisfying the geographical requirements indicated in the location authentication information bound to the authentication key selected by the RP application 350.

FIG. 8 is a flow diagram of an example process 800 for implementing location-based authentication in a computing device. The process illustrated in FIG. 8 can be implemented by the computing device 11 illustrated in FIG. 1-3. The process 800 is, however, an example only and not limiting. The process 800 can be altered, e.g., by having stages added, removed, rearranged, combined, and/or performed concurrently. The process 800 can be used to implement, at least in part, stage 450 of the process 400 illustrated in FIG. 4 where location information is bound to more than one transaction or type of transaction.

The signed authentication response can be provided to the RP application responsive to authenticating the current location information for the computing device. The signed authentication response can be signed using the authentication key that is associated with the particular transaction selected by the RP application (stage 850). In the example illustrated in FIG. 8, the RP application is associated with two authentications keys, and the authentication key corresponding to the particular transaction is one of the first authentication key bound with the first location authentication information or the second authentication key bound with the second location authentication information. In other implementations, an RP application 350 may be associated with more than two or less than two authentication keys. Stage 850 can be implemented similarly to stage 450 of the process illustrated in FIG. 4. The SKM 290 can be configured to sign the signed authentication response with the authentication key of the plurality of authentication keys associated with the transaction that was requested by the user of the RP application 350. The SKM 290 can be configured to receive an authentication token from the location authenticator trusted application 384 responsive to the location authenticator trusted application 384 authenticating the current location of the computing device 11. The SKM 290 may also receive a user authentication token from the user authenticator trusted application 374. The SKM 290 can generate the signed authentication response responsive to receiving the token(s) using the authentication key associated with the requested transaction. The RP application 350 receiving the signed authentication response can determine that the attestation originated from the SKM 290 and that the authentication criteria associated with the requested transaction have been met and can complete the requested transaction.

FIG. 9 is a flow diagram of an example process 900 for implementing location-based authentication in a computing device. The process illustrated in FIG. 9 can be implemented by the computing device 11 illustrated in FIG. 1-3. The process 900 is, however, an example only and not limiting. The process 900 can be altered, e.g., by having stages added, removed, rearranged, combined, and/or performed concurrently. The process 700 can be used to implement stages of the process 400 illustrated in FIG. 4 where location authentication information and user authentication information are both bound to an authentication key of an RP application 350.

Additional authentication information can be bound to the authentication key for the RP application (stage 910). The additional authentication information can comprise user authentication information that can be used to authenticate the user of the computing device 11. The user authentication information can comprise information such as biometric information and/or a password or PIN. The RP application 350 can include a user interface that allows the user to define new and/or edit existing user authentication information. The user interface can be configured to require the user to provide user authentication information, such a pin or password or biometric information to unlock the interface that enables the user to configure the user authentication information. The SKM 290 can be configured to store the additional authentication information with the authentication key in a protected memory area of the TEE. The SKM 290 can be further configured to require that the requirements of the additional authentication information be satisfied, in addition to any location authentication information also bound to the authentication key, before the SKM 290 will generating a signed authentication response using the authentication key.

Additional authentication information can be authenticated based on the additional authentication information bound to the authentication key (stage 920). The SKM 290 can be configured to provide the additional authentication information to the user authenticator unit 270 with a request for user authentication. The user authenticator trusted application 374 of the user authenticator unit 270 can be configured to obtain user authentication information from the from the user of the computing device 11 via the user authenticator HAL 372. The user authenticator trusted application 374 can be configured to prompt the user to provide one or more types of authentication information. For example, the user authentication information can comprise a pin or a password, and the user authenticator trusted application 374 can be configured to display an interface on the computing device 11 requesting that the user to enter the PIN or password. The user authentication information can comprise biometric information. The user authenticator trusted application 374 can be configured to display an interface on the computing device 11 requesting that the user provide one or more types of biometric information depending upon the capabilities of the computing device 11 and the types of biometric information included in the user authentication information bound to the authentication key.

The user authenticator trusted application 374 can be configured to collect one or more of the following types of biometric data. The user authenticator trusted application 374 can be configured to prompt the user to place a finger on a fingerprint sensor so that a fingerprint of the user can be scanned. The user authenticator trusted application 374 can be configured to prompt the user of the position themselves in front of a camera of the computing device 11 so that the camera can be used to capture an image, images, or video content of the user which can be used to perform facial recognition and/or other types of biometric verification of the identity of the user. The user authenticator trusted application 374 can be configured to capture audio content of the user speaking in order to perform voice recognition of the user of the computing device. Other types of biometric data can also be collected in addition to or instead of the examples discussed above, including one or more of typing rhythm, gait pattern, iris pattern, retina pattern, and other types of biometric data.

The user authenticator trusted application 374 can be configured to compare the user authentication information collected with the user authentication information bound to the authentication key to determine whether to authentication the user. The user authenticator trusted application 374 can be configured to generate a user authentication token responsive to the user authentication information collected being satisfying the user authentication information bound to the authentication key selected by the RP application 350. The user authenticator trusted application 374 can also be configured to generate and send an error message to the SKM 290 responsive to the current location of the computing device not satisfying the user authentication requirements indicated in the user authentication information bound to the authentication key selected by the RP application 350.

The signed authentication response can be provided to the RP application responsive to authenticating the current location information and the additional authentication information for the computing device (stage 950). Stage 950 can replace stage 450 of the process of FIG. 4 where an authentication key is bound to both location authentication information and additional authentication information. The SKM 290 can be configured to receive the authentication token from the location authenticator trusted application 384 and to generate a signed authentication response to the RP application 350 responsive to receiving the location authentication token. The SKM 290 can be configured to receive the authentication token from the location authenticator trusted application 384 and a user authentication token from the user authenticator trusted application 374 and to generate a signed authentication response to the RP application 350 responsive to receiving the location authentication token and the user authentication token where the key selected in stage 420 was bound to both location authentication information and user authentication information. The signed authentication response can be signed using an authentication key selected by the RP application 350 and identified in the request for a signed authentication response received at the SKM 290 from the RP application 350. The signed authentication response serves as an attestation by the SKM 290 that the location authentication information and/or the user authentication information requirements bound to the authentication key have been satisfied. The RP application receiving the signed authentication response can determine that the attestation originated from the SKM 290 and that the authentication criteria associated with the requested transaction have been met and can complete the requested transaction.

Other embodiments are within the scope of the invention. For example, due to the nature of software, functions described above can be implemented using software, hardware, firmware, hardwiring, or combinations of any of these. Features implementing functions may also be physically located at various locations, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium,” “computer-readable medium,” and “processor-readable medium” as used herein, refer to any medium that participates in providing data that causes a machine to operate in a specific fashion. Using a computer system, various processor-readable media (e.g., a computer program product) might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible processor-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of processor-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

Information and signals may be represented using any of a variety of different technologies and techniques. For example, data, instructions, commands, information, signals, and symbols that may be referenced throughout the above description may be represented by voltages, currents, electromagnetic waves, magnetic fields or particles, optical fields or particles, or any combination thereof

The methods, systems, and devices discussed above are examples. Various alternative configurations may omit, substitute, or add various procedures or components as appropriate. Configurations may be described as a process which is depicted as a flow diagram or block diagram. Although each may describe the operations as a sequential process, many of the operations can be performed in parallel or concurrently. In addition, the order of the operations may be rearranged. A process may have additional stages not included in the figure.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory processor-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the disclosure. For example, the above elements may be components of a larger system, wherein other rules may take precedence over or otherwise modify the application of the invention. Also, a number of operations may be undertaken before, during, or after the above elements are considered. Also, technology evolves and, thus, many of the elements are examples and do not bound the scope of the disclosure or claims. Accordingly, the above description does not bound the scope of the claims. Further, more than one invention may be disclosed.

What is claimed is:

1. A method of implementing location based authentication in a computing device, the method comprising:
binding location authentication information to an authentication key for a relying party (RP) application;
receiving a request from the RP application for a signed authentication response;
obtaining, at the computing device, current location information for the computing device;
authenticating, at the computing device, the current location information for the computing device based on the location authentication information bound to the authentication key; and
providing, to the RP application by the computing device, the signed authentication response in response to the authenticating the current location information for the computing device, wherein the signed authentication response is signed using the authentication key bound to the location authentication information.

2. The method of claim 1, further comprising providing the signed authentication response without providing the current location information to the RP application.

3. The method of claim 1, further comprising generating the location authentication information at the computing device, wherein the location authentication information is indicative of one or more allowed locations for transactions of the RP application.

4. The method of claim 1, wherein binding location authentication information to an authentication key for a relying party (RP) application comprises binding location information associated with multiple different locations to the authentication key.

5. The method of claim 1, wherein binding location authentication information to an authentication key for a relying party (RP) application further comprises:
binding first location authentication information to a first authentication key for a first transaction of the RP application; and
binding second location authentication information to a second authentication key for a second transaction of the RP application, wherein the second location authentication information is different than the first location authentication information.

6. The method of claim 1, wherein receiving the request from the RP application for the signed authentication response further comprises:
receiving the request from the RP application for the signed authentication response for a particular transaction of the RP application, wherein the particular transaction comprises one of the first transaction or the second transaction.

7. The method of claim 1, wherein authenticating the current location information for the computing device based on the location authentication information bound to the authentication key further comprises authenticating the current location information for the computing device based on bound location authentication information for the particular transaction, wherein the bound location authentication information for the particular transaction comprises one of the first location authentication information or the second location authentication information.

8. The method of claim 1, wherein providing the signed authentication response in response to the authenticating the current location information for the computing device further comprises signing the signed authentication response using the authentication key corresponding to the particular transaction, wherein the authentication key corresponding to the particular transaction comprises one of the first authentication key bound with the first location authentication information or the second authentication key bound with the second location authentication information.

9. The method of claim 1 further comprising receiving the current location information for the computing device from a location authenticator trusted application of the computing device.

10. The method of claim 1, further comprising:
binding additional authentication information to the authentication key for the relying party (RP) application;
authenticating the additional authentication information for the apparatus based on the additional authentication information bound to the authentication key; and
providing, to the RP application by the computing device, the signed authentication response in response to the authenticating the current location information and the additional authentication information for the computing device, wherein the signed authentication response is signed using the authentication key bound to the location authentication information and the additional authentication information.

11. The method of claim 9, wherein the additional authentication information comprises biometric information, device state information, authorization credentials, or a combination thereof

12. An apparatus comprising:
means for binding location authentication information to an authentication key for a relying party (RP) application;
means for receiving a request from the RP application for a signed authentication response;
means for obtaining, at the apparatus, current location information for the apparatus;
means for authenticating, at the apparatus, the current location information for the apparatus based on the location authentication information bound to the authentication key; and
means for providing, to the RP application by the apparatus, the signed authentication response in response to the authenticating the current location information for the apparatus, wherein the signed authentication response is signed using the authentication key bound to the location authentication information.

13. The apparatus of claim 12, further comprising means for providing the signed authentication response without providing the current location information to the RP application.

14. The apparatus of claim 12, further comprising means for generating the location authentication information at the apparatus, wherein the location authentication information is indicative of one or more allowed locations for transactions of the RP application.

15. The apparatus of claim 12, wherein the means for binding location authentication information to an authentication key for a relying party (RP) application comprises means for binding location information associated with multiple different locations to the authentication key.

16. The apparatus of claim 12, wherein the means for binding location authentication information to an authentication key for a relying party (RP) application further comprises:
means for binding first location authentication information to a first authentication key for a first transaction of the RP application, and means for binding second location authentication information to a second authentication key for a second transaction of the RP application, wherein the second location authentication information is different than the first location authentication information.

17. The apparatus of claim 12, wherein the means for receiving the request from the RP application for the signed authentication response further comprises:
means for receiving the request from the RP application for the signed authentication response for a particular transaction of the RP application, wherein the particular transaction comprises one of the first transaction or the second transaction.

18. The apparatus of claim 12, wherein the means for authenticating the current location information for the computing device based on the location authentication information bound to the authentication key further comprises means for authenticating the current location information for the computing device based on bound location authentication information for the particular transaction, wherein the bound location authentication information for the particular transaction comprises one of the first location authentication information or the second location authentication information.

19. An apparatus comprising:
a memory;
a processor coupled to the memory, the processor configured to:
bind location authentication information to an authentication key for a relying party (RP) application;
receive a request from the RP application for a signed authentication response;
obtain, at the apparatus, current location information for the apparatus;
authenticate, at the apparatus, the current location information for the apparatus based on the location authentication information bound to the authentication key; and
provide, to the RP application by the apparatus, the signed authentication response in response to the authenticating the current location information for the apparatus, wherein the signed authentication response is signed using the authentication key bound to the location authentication information.

20. The apparatus of claim 17, wherein the processor is further configured to provide the signed authentication response without providing the current location information to the RP application.

21. The apparatus of claim 17, wherein the processor is further configured to generate the location authentication information at the apparatus, and wherein the location authentication information is indicative of one or more allowed locations for transactions of the RP application.

22. The apparatus of claim 17, wherein the processor is further configured to bind location information associated with multiple different locations to the authentication key.

23. The apparatus of claim 17, the processor is being configured to bind location authentication information to an authentication key for a relying party (RP) application is further configured to:
bind first location authentication information to a first authentication key for a first transaction of the RP application, and bind second location authentication information to a second authentication key for a second transaction of the RP application, wherein the second location authentication information is different than the first location authentication information.

24. The apparatus of claim 17, wherein the processor is further configured to:
receive the request from the RP application for the signed authentication response for a particular transaction of the RP application, wherein the particular transaction comprises one of the first transaction or the second transaction.

25. A non-transitory, computer-readable medium, having stored thereon computer-readable instructions for implementing location based authentication in a computing device, comprising instructions configured to cause the computing device to:
bind location authentication information to an authentication key for a relying party (RP) application;
receive a request from the RP application for a signed authentication response;
obtain, at the computing device, current location information for the computing device;
authenticate, at the computing device, the current location information for the computing device based on the location authentication information bound to the authentication key; and
provide, to the RP application by the computing device, the signed authentication response in response to the authenticating the current location information for the computing device, wherein the signed authentication response is signed using the authentication key bound to the location authentication information.

26. The non-transitory, computer-readable medium of claim 25, further comprising instructions configured to cause the computing device to provide the signed authentication response without providing the current location information to the RP application.

27. non-transitory, computer-readable medium of claim 25, further comprising instructions configured to cause the computing device to generate the location authentication information at the computing device, wherein the location authentication information is indicative of one or more allowed locations for transactions of the RP application.

28. The non-transitory, computer-readable medium of claim 25, wherein the instructions configured to cause the computing device to bind location authentication information to an authentication key for a relying party (RP) application further comprise instructions configured to cause the computing device to bind location information associated with multiple different locations to the authentication key.

29. The non-transitory, computer-readable medium of claim 25, wherein the instructions configured to cause the computing device to bind location authentication information to an authentication key for a relying party (RP) application further comprise instructions configured to cause the computing device to:
bind first location authentication information to a first authentication key for a first transaction of the RP application; and
bind second location authentication information to a second authentication key for a second transaction of the RP application, wherein the second location authentication information is different than the first location authentication information.

30. The non-transitory, computer-readable medium of claim 25, wherein the instructions configured to cause the computing device to receive the request from the RP application for the signed authentication response further comprise instructions configured to cause the computing device to:
receive the request from the RP application for the signed authentication response for a particular transaction of the RP application, wherein the particular transaction comprises one of the first transaction or the second transaction.
